(19) United States
(12) Patent Application Publication
(10) Pub. No.: US 2004/0252709 A1
(43) Pub. Date: Dec. 16, 2004

(54) System having a plurality of threads being allocatable to a send or receive queue

(76) Inventor: Samuel A. Fineberg, Palo Alto, CA (US)

Correspondence Address: HEWLETT-PACKARD COMPANY, Intellectual Property Administration, P.O Box 272400, Fort Collins, CO, 80527-2400, US

(21) Appl. No.: 10/458,817

(22) Filed: Jun. 11, 2003

(51) Int. Cl. H04L 12/28; G06F 15/16; H04L 12/56

(52) U.S. Cl. 370/412; 709/201; 719/312

(57) ABSTRACT

A computer system is disclosed that comprises a processor, a plurality of receive queues coupled to the processor into which client requests are stored, a plurality of send queues coupled to the processor into which response information is stored, and a plurality of threads comprising a unit of execution by the processor. Each thread may be allocatable to a send or receive queue.

### BACKGROUND

Computer networks typically include one or more servers coupled together and to various clients and to various input/output (“I/O”) devices such as storage devices and the like. Application programs may be executed on the clients. To perform the functions dictated by their applications, the clients submit requests to one or more servers. The workload placed on the servers thus is a function of the volume of requests received from the clients. Improvements in efficiency in this regard are generally desirable.

### BRIEF SUMMARY

Various embodiments are disclosed herein which address the issue noted above. In accordance with some embodiments, a computer system is disclosed that comprises a processor, a plurality of receive queues coupled to the processor into which client requests are stored, a plurality of send queues coupled to the processor into which response information is stored, and a plurality of threads that each comprise a unit of execution on the computer system. Each thread may be allocatable to a send or receive queue.

### BRIEF DESCRIPTION OF THE DRAWINGS

For a detailed description of the embodiments of the invention, reference will now be made to the accompanying drawings in which:

FIG. 1 shows a system comprising a client and a server in accordance with various embodiments of the invention;

FIG. 2 shows an embodiment of the server of FIG. 1;

FIG. 3 shows another embodiment of the server of FIG. 1;

FIG. 4 shows yet another embodiment of the server of FIG. 1;

FIG. 5 shows an embodiment of a message buffer usable in the server of FIG. 1;

FIG. 6 illustrates the function of a receive thread processing a non-RDMA client request;

FIG. 7 illustrates the function of a send thread processing a response completion;

FIG. 8 illustrates the function of a receive thread processing a client request including RDMA; and

FIG. 9 illustrates the function of a send thread processing a RDMA operation completion.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to.”. Also, the term “couple” or “couples” is intended to mean either an indirect or direct connection. Thus, if a first device couples to a second device, that connection may be through a direct connection, or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

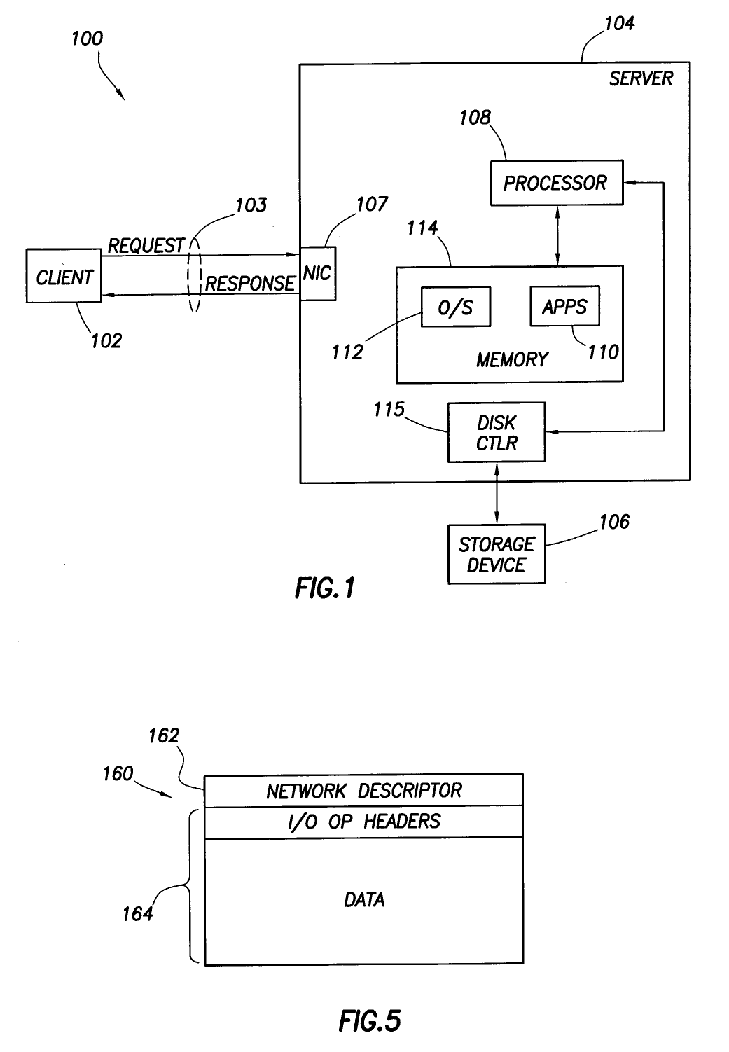

Referring now to FIG. 1, one or more clients 102 operatively couple to one or more servers 104 via a communication link 103. Although only one client 102 is shown operatively connected to server 104, in other embodiments more than one client 102 may be operatively connected to the server. The server 104 also couples to a storage device 106. The storage device 106 may be separate from, or part of, the server 104 and may comprise one or more hard disks or other suitable storage devices. In some embodiments, the server 104 may be a computer such as an input/output (“I/O”) server that performs I/O transactions on behalf of a client 102. An example of an I/O transaction includes an access to storage device 106. The client 102 also may comprise a computer. The client 102 may submit an I/O request to the server 104 and the server may perform the desired I/O transaction and provide a response back to the client.

As shown in FIG. 1, the server 104 may include one or more processors 108 that execute one or more applications 110 and one or more operating systems (“O/S”) 112. The applications 110 and operating system 112 may be stored in memory 114 associated with the server 104. The server also may include one or more network interface controllers (“NICs”) 107 and disk controllers 115 configured to control access to the storage device 106. Other components (not specifically shown) may be included as desired.

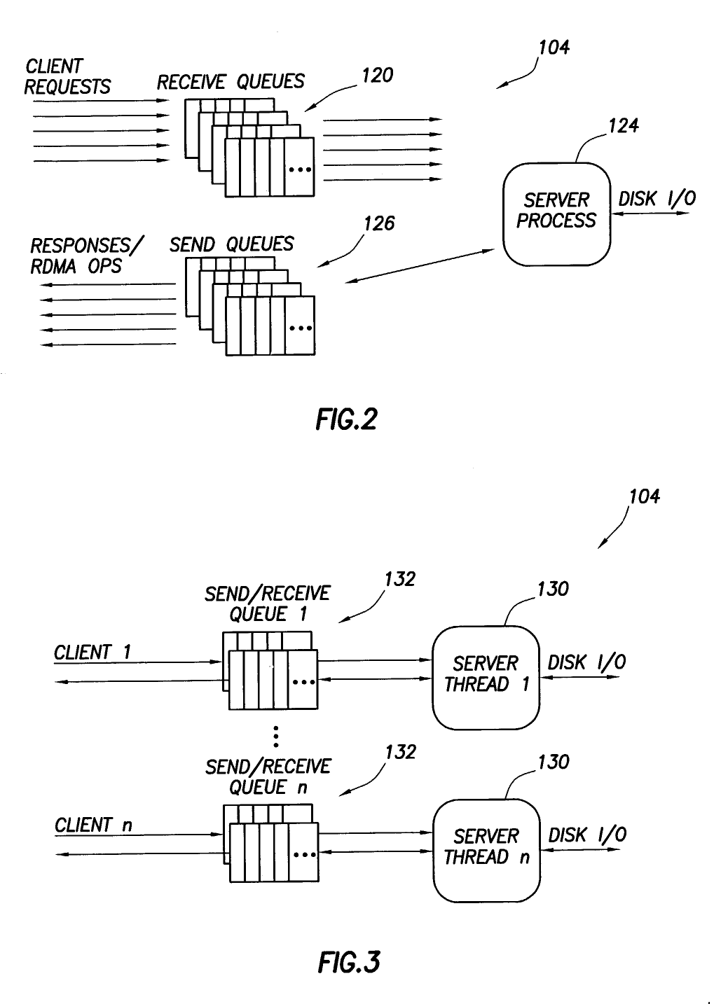

FIG. 2 shows an exemplary embodiment of the server 104 having one or more receive queues 120, a server process 124 and one or more send queues 126. The receive and send queues 120, 126 may exist within the server's memory 114 or in memory on the NIC 107. The server process 124 may be implemented as one or more applications 110 running on the server's processor 108. Requests from a client 102 may be received by the server 104 and stored in a receive queue 120. The server process 124 may perform one or more of the following actions: scan the receive queues 120 for incoming requests, dequeue a request and pre-post another receive, perform the I/O operation associated with a client request, post a response to a send queue 126, and wait for the response to complete (i.e., be received by the client). Preposting a receive refers to posting a message buffer 160 (FIG. 5) to the receive queues 120 to provide storage for an incoming I/O request.

The client requests processed by the server 104 of FIG. 2, as well as in the other server embodiments also described herein, may include requests for data stored on the storage device 106. Client requests may be sent as messages from a client 102 and received by a server 104. The data transferred as a result of a client request may be included as part of the request or response message. Alternatively, the data may be moved using remote direct memory access (“RDMA”) to or from the server 104. In an RDMA operation, the server 104 may move data directly into or out of a client's memory (not specifically shown) without the involvement of the client's CPU (also not specifically shown).

At least some embodiments of the server 104 include multiple storage devices 106, multiple NICs 107, multiple processors 108, and/or multiple disk controllers 115. These resources may function independently from each other. Accordingly, some embodiments of the invention include a server that implements “pipelining” in which multiple client requests are processed concurrently. FIG. 3 depicts a server 104 having one or more send/receive queue pairs 132. The server 104 also may include a thread 130 for each send/receive queue pair 132 with a separate thread 130 being allocated for each send/receive queue pair 132. Each thread 130 may have access to the resources (i.e., memory, storage devices, network, etc.) necessary to carry out the client requests and provide the associated responses with respect to a single send/receive queue pair 132. In the embodiment of FIG. 3, each thread 130 may be statically allocated to the corresponding send/receive queue pair 130. “Statically allocated” means that each send/receive queue pair 130 has a predetermined thread dedicated for use for that queue pair.

For purposes of this disclosure, a “thread” generally refers to a unit of execution on a computer system. Each thread may have its own instruction stream and local variables (i.e., stack). Multiple threads may execute simultaneously on a multiprocessor system. Threads may run within the context of a process, which includes, for example, code, global variables, heap memory, and I/O. If more than one thread runs within a single process they may run independently and they may share process resources. As described herein, all threads described in the embodiments may run within a single process. The process may be a user-space process or the operating system kernel.

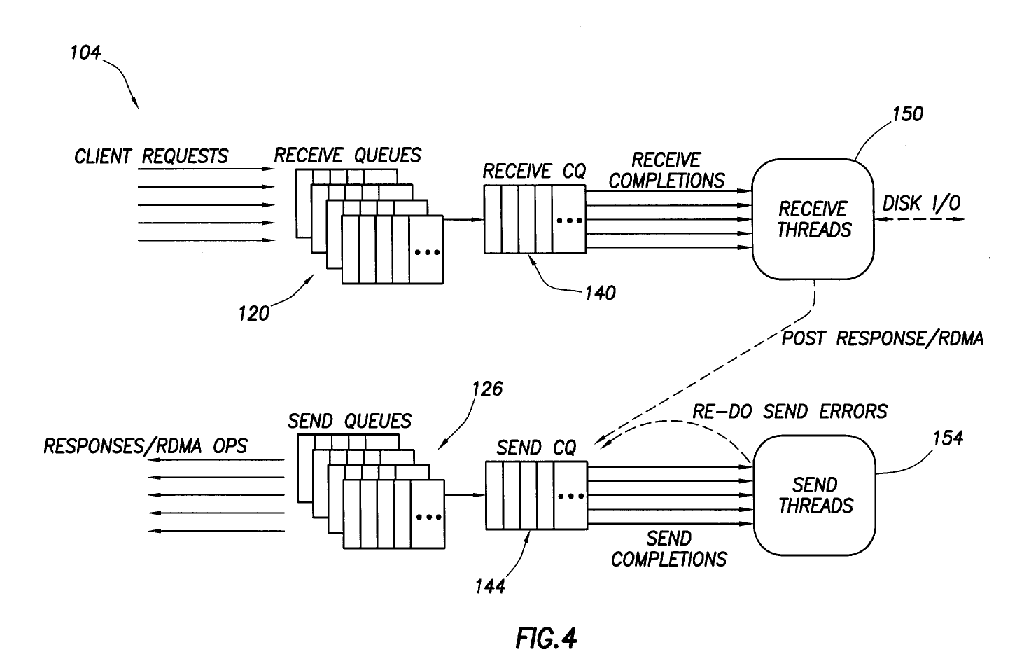

In accordance with other embodiments of the invention as exemplified in FIG. 4, the server 104 may include one or more “pools” of threads (i.e., one or more collections of available threads). The threads from this pool may be dynamically allocated during runtime. In the embodiment of FIG. 4, server 104 may include one or more receive queues 120, one or more send queues 126, a receive completion queue 140, a send completion queue 144, a pool of receive threads 150, and a pool of send threads 154. The send and receive queues 126, 120 may be decoupled from each other as shown in FIG. 4. Further, completions may be stored in separate send and receive completion queues 144, 140.

In this architecture, the completions may be serviced by the two distinct pools of threads 150, 154. The receive threads 150 may service client requests and perform the operations needed to implement the requests. The send threads 154 may service send and RDMA completions previously issued by receive threads 150. With the embodiment of FIG. 4, client requests may be processed in a pipelined fashion. As receive descriptors (described below) in the various receive queues 120 complete, the received requests may be serviced by separate threads from receive thread pool 150. Completed RDMA and send descriptors from the send queues 126 may also be processed concurrently by the pool of send threads 154. As such, multiple client I/O requests may be processed concurrently by the various functional units in the server 104, thereby potentially increasing efficiency and throughput. Any number of threads may be provided in each pool 150, 154. Maximum throughput may be achieved if a sufficient number of threads are available. For example and without limitation, if the storage device 106 can process 20 requests simultaneously, and the network has the ability to service four data streams simultaneously, then 24 threads may be provided for maximum throughput to process requests. A lower or higher number of threads may be provided as well in accordance with other embodiments.

The server 104 may be implemented as a user-space program running under an operating system (e.g., Windows 2000, Linux). However, the principles described herein also may apply to kernel-based servers. File operations may be handled with a “request-response” model. As such, a client may send a request to the server 104 for a file operation. The server 104 may perform the requested operation with the results being returned to the client in a response. The file operations may include functions such as open, close, read, write, read/write file attributes, and lock/unlock a file.

Referring still to FIG. 4, when a request message is received from any of the connected clients, the message may be received by the NIC 107 using descriptors from the receive queues 120 in a pre-posted message buffer 160 (FIG. 5). Then, a receive completion is posted on the server's receive completion queue 140. These completions are processed by the receive threads 150. When the server 104 completes processing an I/O request, the receive thread that processed the request may post a response message to one of the send queues 126. In addition, receive threads 150 may post RDMA operations to one of the send queues 126 to move data directly to/from the client's memory. As send descriptors in the send queues 126 complete, completions will be posted to the send completion queue 144. These completions are processed by the send threads 154.

The server 104 may allocate a pool of message buffers such as buffer 160 shown in FIG. 5. These message buffers may be used to store incoming requests as well as to build response messages. Each buffer 160 may be of a fixed size. As shown, each message buffer 160 may include a control section 162 and a data section 164. The control section 162 may contain a network (e.g., VIA) descriptor which indicates the operation the NIC should perform (i.e., send, receive, RDMA read, RDMA write), as well as the parameters for the NIC operation (i.e., client/server memory addresses, transfer size, memory protection handle, etc.). The data section 164 of a message buffer may be of any size, but, without limitations, may be sized to fit a maximally sized network request/response packet. When a message is sent or received, the network descriptor in the control section 162 may be used by the server's NIC 107 to specify the details of the network operation. The data section 164 may contain the data to be sent (for a send operation), or a space allocation into which the NIC 107 may store a received message (for a receive operation). For RDMA operations, the control section 162 may contain the network descriptor, but the data may be stored in a separately allocated buffer. The message buffer data section 164 for an RDMA operation may be used to store a synchronization variable that can be used by a server thread to wait for the completion of the RDMA operation and to store status information that can be used to indicate the outcome of the operation and coordinate the send and receive threads. For RDMA operations, the message buffer data section 164 generally is not transferred through the network. Instead, a separate buffer pool is used to store the RDMA data. The message buffer pool may be managed by the server threads 150, 154, and may be pre-registered when the server 104 is initialized. “Pre-registered” means that the memory buffer has been mapped for use by the NIC 107 and may include the locking of the buffers in the server's physical memory (to prevent the buffers from being moved or paged to disk) and the creation of memory translation tables in the NIC 107.

The server 104 may pre-post a fixed number of receive message buffers prior to accepting connections to one or more clients. All message completions may be routed to the receive completion queue 140 or the send completion queue 144. The receive threads 150 and send threads 154 may process messages from the receive and send completion queues 140 and 144, respectively.

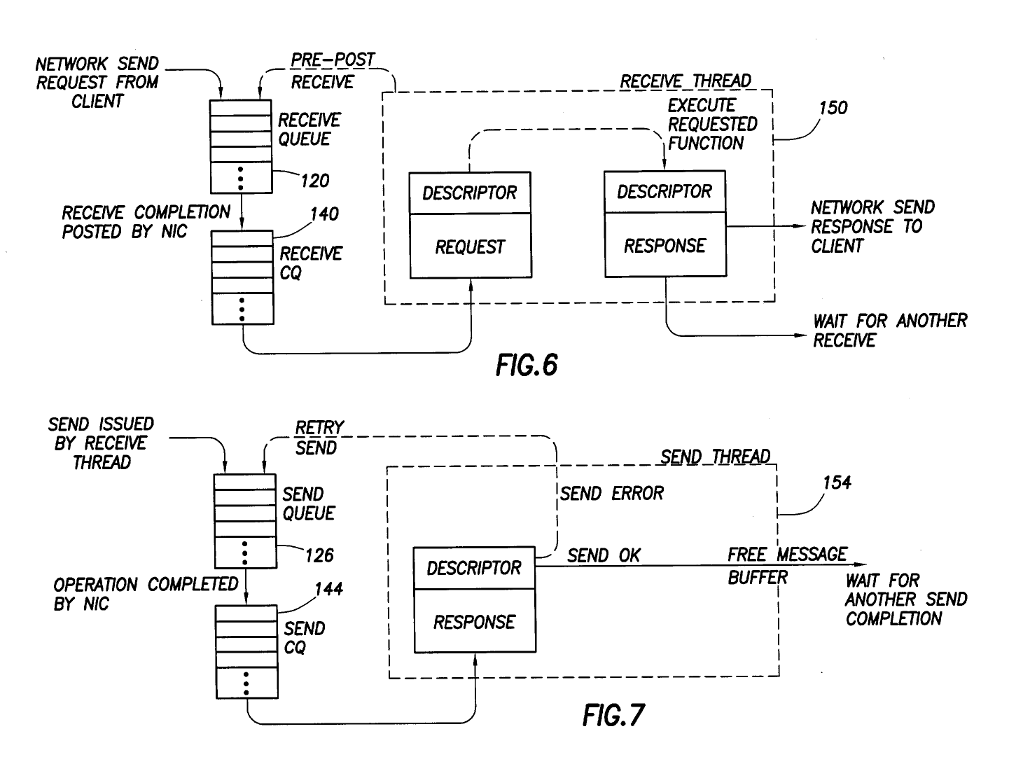

Referring now to FIG. 6, when the server 104 receives a request from a client, the NIC 107 matches the request against one of the pre-posted buffers in the server's receive queue 120. A completion then may be written to the receive completion queue 140. If the receive completion queue 140 is empty when a request arrives, the enqueing of the completion may wake up one of the waiting receive threads 150. If the receive completion queue 140 is not empty, the completion may be stored in the queue until a receive thread 150 become available to process the completion. The receive thread 150 may pre-post another receive descriptor to the receive queue 120 of the client connection on which the request was received. The receive thread 150 then may examine the request in the data portion 164 of the message buffer 160 associated with the completed receive. The thread 150 may carry out the operation associated with the request. If the request does not require RDMA data transfer, the receive thread 150 may initiate the requested I/O operation (e.g., reading or writing file blocks, reading file directory information, and opening a file) and wait for the operation to complete. A message buffer may be allocated and a response (including the status of the file operation and any data that is to be returned to the client) may be created in the message buffer's data section 164. The message buffer's control section 162 may specify a send operation to the request's originator using the same connection on which the request was received. The receive thread 150 may place a send in the connection's send queue, free the request message buffer, and wait for more work on the receive completion queue 140.

Referring to FIG. 7, the send threads 154 also may wait for work on a send completion queue 144. As in the receive case described above, when a send operation completes, one of the send threads 154 may be another or the send operation may be enqueued if all send threads are busy. At least two classes of operations may appear in a send queue 126: the sends associated with response messages and RDMA read or write operations. In either case, if an error is detected in the operation's status, the send or RDMA operation may be re-issued by the send thread 154. An example of an error may include an uncorrectable transmission error or the loss of a connection between a client and server. The send thread 154 may detect if an operation has repeatedly failed, may stop issuing the operation, and may report an error. When a response message completes successfully, the send thread 154 may free the message buffer and resume waiting for more send completions. When an RDMA read or write completes successfully the issuing thread may be notified. This action is explained below.

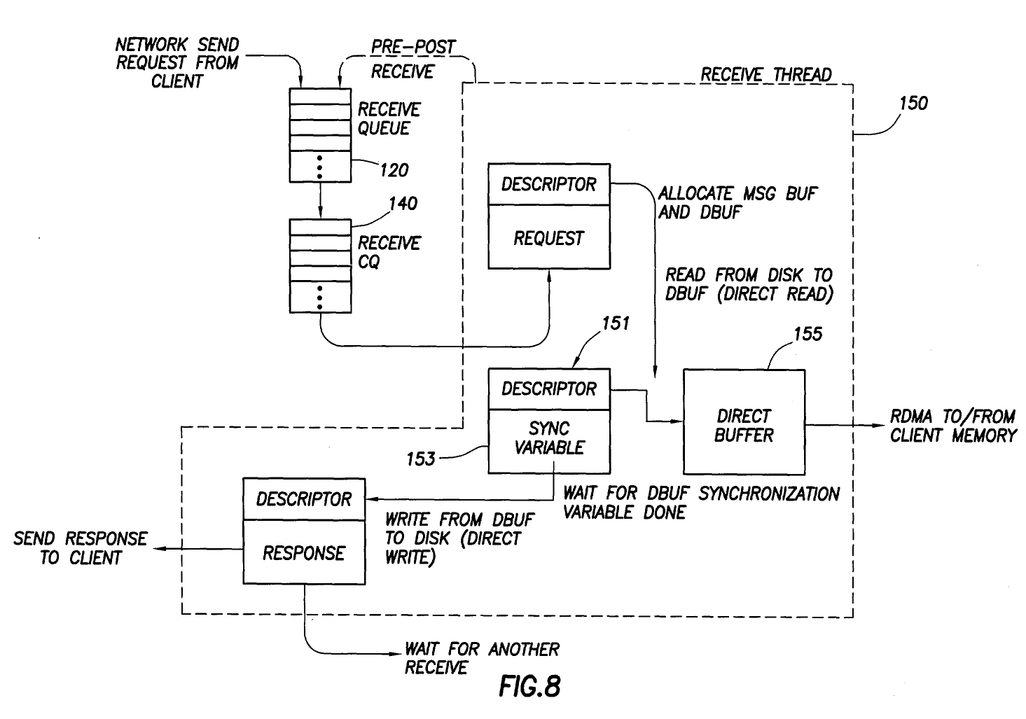

Direct read and write operations may be similar to the previously described operations, except the bulk data transfer is done via RDMA. Referring to FIG. 8, upon initializing the server 104, one or more direct buffers (“dbufs”) 155 may be allocated. Dbufs 155 may comprise memory buffers that are used to stage data from the network to storage or from storage to the network. These dbufs 155 may be of any size and may be sized to hold the largest block of data that may be moved in a single RDMA transfer (a configurable parameter for the server). Without limitation, dbufs 155 may be larger and fewer in number than message buffers. A sufficient number of dbufs 155 may be present to satisfy all possible outstanding direct read and write operations. The dbufs 155 may be pre-allocated and pre-registered to improve server efficiency.

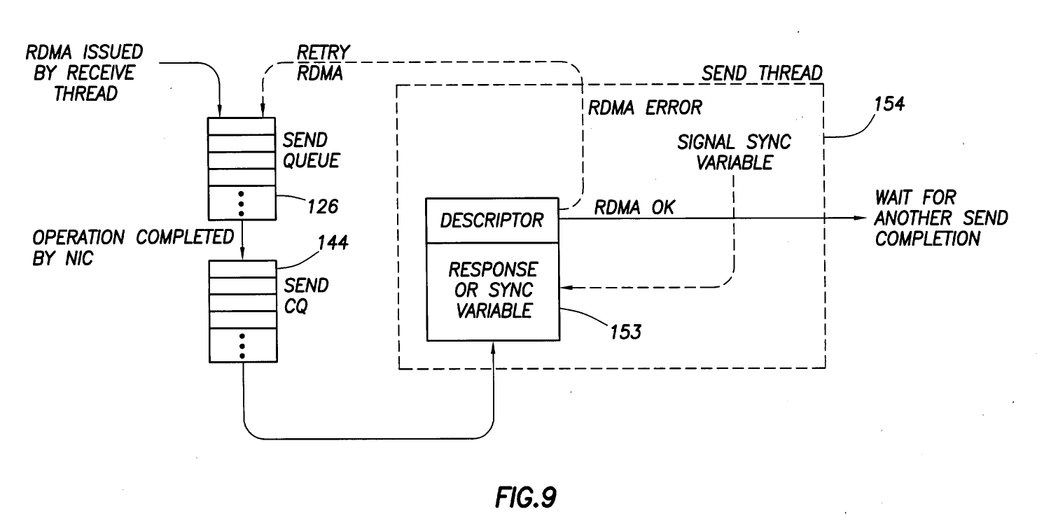

FIGS. 8 and 9 illustrate the process by which receive and send threads process an RDMA read or write from a client. As described above, requests may be sent to the server 104 by a client and stored in pre-posted receive message buffers by the NIC 107. A receive thread 150 may retrieve the request's message buffer from the receive completion queue 140. The receive thread 150 may allocate an extra message buffer 151 and a dbuf 155 for the RDMA operation. If the request comprises a direct write to storage (e.g., storage 106), one or more RDMA reads (using the descriptor in the control section 162 of the extra message buffer 151) may be initiated to move the bulk data directly from the client's memory into the dbuf 155. After posting an RDMA read, the receive thread 150 may wait on the synchronization variable 153 contained in the data section 164 of the extra message buffer. When the RDMA read completes, a completion may appear in the send completion queue 144.

The completion may be read by a send thread. Referring to FIG. 9, the send thread 154 may re-issue the RDMA operation if there was an error, or signal the synchronization variable 153 if the RDMA operation completed successfully. Upon waking up, the receive thread 150 may perform the I/O write command to write the data from the dbuf to the storage device 106.

For a direct read, a similar sequence may occur. The receive thread 150 may allocate the dbuf 155 and issue the I/O read command to move the data from the storage device 106 to the dbuf. Then, if the I/O completes correctly, the receive thread 150 may issue one or more RDMA writes (using the descriptor in the extra message buffer 151) to write the data directly from the dbuf 155 to the client's memory (not specifically shown). The receive thread 150 may wait on the synchronization variable 153 in the extra message buffer, which is signaled by a send thread 154 upon correct completion of the RDMA write.

While some embodiments of the server 104 may limit direct read and write operations to the size of one dbuf 155, in other embodiments arbitrarily large direct read or write operations may be implemented. In such embodiments, this may be accomplished by alternating between RDMA reads/writes and performing storage device I/O with units of data commensurate in size with dbuf 155. For example, a direct read could fill a dbuf 155 with data from disk. An RDMA may occur to write the contents of dbuf 155 to the client. When the RDMA write completes, the process may repeat for additional blocks of data until the I/O request has been satisfied.

After the data transfer and I/O have completed for both read and write, the dbuf 155 and extra message buffer 151 may be freed and the original receive message buffer is used to respond to the client. The response status fields may be filled in, and it may be sent to the client as described previously. The receive thread 150 then may resume waiting on the receive completion queue for more work.

In accordance with another embodiment of the invention having a dynamically allocatable thread pool, the logical connection between the server 104 and a client may be locked and unlocked. In this context, the term “lock” means that at any given time only a single thread, and therefore only a single client request, may issue sends or receive messages from a specific client connection (send/receive queue pair). When a thread finishes with a connection, the thread may unlock the connection, allowing any thread to service requests from that client connection. A thread from the receive thread pool 150 may scan the receive queues 120 and may take control of a connection's send/receive queue pair when a pending request is discovered. In such an embodiment, a receive thread thus may:

scan its receive or completion queues for incoming requests,

pick a receive queue with an incoming request and lock the connection (i.e., the send and receive queues) to obtain exclusive access,

dequeue the request and pre-post another receive,

perform the requested I/O including any RDMA,

post a response on a send queue,

wait for the response to complete, and

release the connection lock.

With the “locked” embodiment, receive threads may subsume the function of the send threads. Therefore, a receive thread may wait for the completion of its own RDMA and send operations. As a result, the receive thread may wait on the connection's send queue, rather than waiting on a synchronization variable set by a send thread. This process may be more efficient if the synchronization variable overhead is larger than the overhead and lack of concurrency caused by locking the queue. However, with this embodiment only one operation may be outstanding at a time for each network connection (i.e., send/receive queue pair).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A computer system, comprising:
a processor;
a plurality of receive queues coupled to said processor into which client requests are stored;
a plurality of send queues coupled to said processor into which response information is stored; and
a plurality of threads that each comprise a unit of execution on said computer system, each thread being allocatable to a send or receive queue.

2. The computer system of claim 1 wherein said plurality of threads comprise a pool of receive threads that are dynamically allocatable to said receive queues and a pool of send threads that are dynamically allocatable to said send queues.

3. The computer system of claim 2 wherein the pools of receive and send threads collectively include 24 threads.

4. The computer system of claim 1 wherein said plurality of threads comprise a pool of receive threads that are statically allocatable to said receive queues and a pool of send threads that are statically allocatable to said send queues.

5. The computer system of claim 1 wherein, upon completion of a client request, said processor releases a thread that was allocated to perform said client request.

6. The computer system of claim 1 wherein said processor can lock a thread to a receive or send queue for exclusive use by said queue.

7. The computer system of claim 6 wherein said processor can unlock said thread and once unlocked said thread can be used in conjunction with other queues.

8. The computer system of claim 1 wherein said server processes client requests that comprise direct memory accesses to or from a device external to said server.

9. The computer system of claim 1 wherein said processor posts a message buffer to a receive queue, said message buffer providing storage for a client request.

10. A server, comprising:
a processor;
a plurality of receive queues coupled to said processor into which client requests are stored;
a plurality of send queues, separate from said receive queues, coupled to said processor into which response information is stored; and
a pool of receive threads processes said client requests and each thread comprises a unit of execution on said server and each receive thread being dynamically allocatable to a receive queue; and
a pool of send threads each comprising a unit of execution on said server and that service send completions previously issued by receive threads, each send thread being dynamically allocatable to a send queue;
wherein said receive and send queues can be executed concurrently by said processor.

11. The server of claim 10 further comprising a receive completion queue into which receive completions are stored pending being processed by a receive thread.

12. The server of claim 11 further comprising a send completion queue into which send completions are stored pending being processed by a send thread.

13. The server of claim 10 further comprising a send completion queue into which send completions are stored pending being processed by a send thread.

14. The server of claim 10 wherein the server sends data to or receives data from a client using remote direct memory access.

15. A method of processing requests, comprising:
receiving a request from a request originator;
storing said request in one of a plurality of receive queues;
allocating a receive thread to process said request, said receive thread comprising code executable by a processor;
processing said request by said receive thread;
said receive thread providing responsive information to the originator following the execution of the request; and
allocating a send thread to process a completion of said response.

16. The method of claim 15 further comprising allocating a message buffer into which requests can be stored.

17. A system, comprising:
a processor;
a plurality of receive queues coupled to said processor into which client requests are stored;
a plurality of send queues coupled to said processor into which response information is stored; and
a means for processing multiple requests concurrently.

18. The system of claim 17 further comprising a means for providing response messages to a client.
